(19) United States
(12) Patent Application Publication
(10) Pub. No.: US 2010/0162094 A1
(43) Pub. Date: Jun. 24, 2010

(54) PROVIDING INTERACTIVE FORMS IN WEB APPLICATION SOFTWARE

(76) Inventor: Craig Bolon, Newton, MA (US)

Correspondence Address: IP Patent Docketing;K&L GATES LLP, 599 Lexington Avenue, 33rd Floor, New York, NY, 10022-6030, US

(21) Appl. No.: 12/548,146

(22) Filed: Aug. 26, 2009

Related U.S. Application Data
(60) Provisional application No. 61/190,212, filed on Aug. 27, 2008.

(51) Int. Cl. G06F 17/20

(52) U.S. Cl. 715/222

(57) ABSTRACT

Systems and processes for providing interactive forms in Web application software and described. Example embodiments provide for receiving a specification of an interactive form, including an ordered sequence of components specifying text input fields and line separators. Embodiments also provide for dynamically generating interactive forms for display according to the specification.

### CROSS-REFERENCE TO RELATED APPLICATIONS

This application claims priority to U.S. Provisional Patent Application No. 61/190,212, filed on Aug. 27, 2008, the entirety of which is incorporated by reference herein.

### BACKGROUND

Since development of FLOW-MATIC and later COBOL, starting with the B-0 compiler testing under leadership of Grace M. Hopper at Sperry Rand Corp. in 1957, computers have been able to prepare data entry forms and interpret information using words of natural languages. Forms were first presented on paper, but soon cathode ray tube displays developed for oscilloscopes, radar and television were adapted for use as computer displays, making possible interactive forms. Interactive forms became a practical technology with the development of online transaction processing software serving large numbers of simultaneous computer users and the development of free-standing hardware encapsulating routine aspects of data input and display.

The Digital® VT05 terminal introduced free-standing computer hardware combining an electronic keyboard, asynchronous digital communication and automatic character generation for raster-scan video. The IBM® 3270 terminal introduced commercially a technology providing fields automatically presented on a display screen, each described by starting position, length, data entry acceptance, color and other attributes. This terminal's operation became a model used for small computer software and displays as “personal computers” became available in the mid-1970s and widespread by the mid-1980s. Products providing the 3270 approach to interactive forms continue to be available.

A different approach to interactive forms evolved from “hypertext” documents described by Tim Berners-Lee in 1989, as distributed over networks. These became known as “Web pages.” Web page viewing programs called “browsers” request, receive and display documents in hypertext “markup” language, or HTML, and they may return responses. As a realization of the “memex” concept described by Vannevar Bush, director of the U.S. Office of Scientific Research and Development from 1941 to 1947, Web pages were intended to provide linked nodes of information. The first version of HTML included page links and generic formats such as “title” specified in “tags,” leaving details of display positioning and expression to a browser. Subsequent extensions to HTML in a second major version and several revisions included images, tables and forms, with form elements asking browsers to accept user inputs in several formats, including typed-in numbers, typed-in text and checkbox marks, and to return them as responses.

The third major version of HTML included “style sheets,” allowing an HTML document to describe appearances for groups of elements but not individual elements. In 1997 a version 3.2 specification for HTML was published, reserving style attributes for elements. Later that year a specification for the fourth major version of HTML was published, describing style attributes in a Cascading Style Sheets, or CSS, specification. Version 4 of HTML using CSS Level 2 was soon widely implemented, and it remained fairly stable for more than ten years. By the mid-1990s, as browsers and server computer software supporting HTML versions 3 and 4 became generally available and reliable, it was practical, although laborious, to write application software employing Web pages to communicate with computer users, through interactive forms composed in HTML.

Several sets of software development tools for coordinated sets of Web pages, or Web application software, appeared by the late 1990s. The JBuilder® tool set, developed by Borland® and used with software support environments available from Embarcadero Technologies, Sun™ Microsystems, Oracle® and IBM, provides Java™ as a language for writing software that runs on Web page server computers, called Web servers. JBuilder was first released in 1996. The Microsoft® Visual Studio® tool set, used first with the Microsoft Active Server Pages or ASP software support environment and later with the Microsoft ASP.NET software support environment, provides multiple languages for writing software that runs on Web servers. Visual Studio was first released in 1997; by 2002 it supported four languages. Web application tool sets generate programs that can (a) compose HTML documents and send them to browsers running on user computers and (b) receive and interpret responses and satisfy requests for documents from browsers running on user computers. HTML documents that these programs compose are typically augmented with JavaScript,® ECMAScript,™ JScript® or VBScript, to be interpreted and executed by browsers in performing coordinating functions.

Web application tool sets allow software writers to configure fields of a Web page with “controls” referenced in markup descriptions of pages. The markup languages are extensions of HTML in which controls are designated by names and attributes taking the places of ordinary HTML tag names and attributes. The software support environments for these tools link HTML elements and controls designated in markup with software objects inside application programs. When generating a Web page, they interpret data in Web server software objects to provide attributes for HTML elements and controls, and they translate controls to HTML equivalents. When processing a response, they interpret response data to provide properties for associated software objects and to invoke functions that can respond to user inputs. Web application tool sets also allow software writers to add HTML elements and controls to a Web page dynamically and to retrieve response data associated with such dynamic elements and controls, using software functions. These tool sets and software support environments make it feasible to compose and use interactive forms with more productivity and flexibility than prior technologies.

Proficiency with HTML and Web application tool sets can take substantial time to achieve. There are needs to extend services available with these resources to people who are not software writers. While full use of HTML and Web application tool sets probably cannot be much simplified, some needs can be satisfied with limited sets of resources. Many people working with software applications are faced with changes over time to the organization of information, such as accountants coping with new regulations, medical personnel coping with new quality of care standards and office workers at manufacturers coping with new requirements for records about environmental hazards. For people who are not software writers to address such changes when using Web application software, among other things they need a reasonably simple way to compose and modify the interactive forms they use to enter, edit and view information held in computer records. A form management technology should support full integration into a Web application, so that an application can provide both the presentation and recording of forms for normal operations and the composition and modification of forms for configuration.

While there are flexible and automatable ways to compose and store information that readily accept organizational changes, such as XML, simple yet similarly flexible and automatable ways to compose and modify interactive forms are not generally available to embed in Web application software. While HTML provides a way to specify forms, its visual attributes are complex. Moreover, programs written with Web application tool sets do not accept conventional specifications for added or changed HTML elements and associate those elements with added or changed software objects while they are running. Additions or changes driven by such specifications require using the tools. Satisfying needs of people who are not software writers to address changes in organization of the information they work with through interactive forms, when using Web application software, will require simple yet flexible ways to specify forms and associated form data, implemented through functions embedded in Web application software, and flexible ways to display forms, validate, acquire and interpret form inputs, and manage form data, based on such specifications and also embedded in Web application software.

### Description of Earlier Systems

XForms is a well known technology for interactive forms, inspired by XML. Like HTML and Web application tool sets, XForms is complex; proficiency can take substantial time to achieve. Requirements by the institutional custodians of XForms that private companies involved with it comply with potentially complex and difficult policies may have affected some potential investments in the technology. Whatever the reasons may be, in contrast to the rapid implementations of successive versions of HTML that occurred during the 1990s, at seven years after the first publication describing the XForms technology commercially written and maintained, widely used browsers had yet to implement it.

At that point in the evolution of XForms, an interactive form specified using the technology could be implemented by Web server software that translates such a form to HTML and uses technologies available from Web application tool sets and their software support environments to send the resulting document and receive inputs. An interactive form specified using XForms could also be implemented using software, written mainly in JavaScript or another widely supported script language, that presents a form, specified in an XForms document or subdocument and augmented by script language software, and then acquires inputs and transmits them as a response, when the software written in a script language is interpreted and executed by a browser. As other alternatives, an interactive form that has been specified using XForms could be implemented by form presentation software running on a user computer or by software that augments a browser by extending its capabilities so as to display such a form and to transmit its inputs in a response. One approach to reducing the complexity of composing and modifying interactive forms based on XForms is a visual form editor tool operating through a browser. However, none of the form management software technologies based on XForms that are described in this paragraph are designed for full integration into a Web application, so that the application can provide both the presentation and recording of forms for normal operations and the composition and modification of forms for configuration.

Using proprietary form and data representations, several products have been provided to compose and modify forms, present forms and record inputs, with several types of operation, including operation through browsers. Some such products are available as FormMaker Pro,™ Bridge, InfoCapture,™ JotForm,® and Web Form Builder.™ These products all operate as free-standing or server-based tools. None of these products are designed for full integration into a Web application, so that the application can provide both the presentation and recording of forms for normal operations and the composition and modification of forms for configuration.

### SUMMARY

Some example embodiments of the present invention provide a process for providing interactive forms in Web application software, which may include receiving, with a Web application server, a specification of an interactive form, the specification including an ordered sequence of components, wherein said components specify at least fields and line separators, and wherein said fields have field widths; storing the specification, with the Web application server; dynamically generating, with the Web application server, the interactive form for display according to the specification, wherein the interactive form is automatically configured as one or more lines, each with one or more field points, wherein all of said field points on one of said lines have equal spacing, wherein said spacing of field points on all of said lines is the same, wherein said spacing of field points is equivalent to at least twice the width of a typical displayed character, wherein the position of the first of said fields on one of said lines begins at the first of said field points on said line, and wherein the position of each successor field after said first field on one of said lines begins at the next of said field points on said line following the end of the immediate predecessor field.

In some example embodiments, one or more of said field widths may be specified in said specification.

In some example embodiments, one or more of said field widths may be set by defaults.

Some example embodiments may further include automatically generating an internal symbol to identify at least one of the fields, the internal symbol reflecting the line ordinal and the field point ordinal at the start of said field as displayed.

Some example embodiments may further include receiving data corresponding to said fields in said interactive form from user inputs for said fields.

In some example embodiments, the specification may be stored in a form representation that differs from a form composition document.

In some example embodiments, the specification may be stored as a form composition document.

Some example embodiments further include storing the data in a form data representation that differs from a form composition document.

In some example embodiments, said at least one of the fields may be one of a text input field, a decimal integer input field, decimal fractional number input field, a checkbox mark input field, and a list selection input field.

In some example embodiments, at least one of the fields may include a field width attribute.

In some example embodiments, at least one of the fields may be a list selection input field and include an attribute specifying a list of selection option labels.

In some example embodiments, said form composition components may include an annotation element for marking the end of an input field specification.

In some example embodiments, said form composition components may include an annotation element for a field reference.

In some example embodiments, said field may include a field reference annotation.

In some example embodiments, said form composition components may include an annotation element for specifying a field default value, including a field reference.

In some example embodiments, at least one of the fields may be matched through said field reference annotation with the field reference of an annotation element specifying a default value.

In some example embodiments, said form composition components may include an annotation element for specifying a field external symbol, including a field reference.

In some example embodiments, at least one of the fields may be matched through said field reference annotation with the field reference of an annotation element specifying a field external symbol.

In some example embodiments, said form composition components may include an annotation element for specifying a list of selection option labels.

In some example embodiments, at least one of the fields may be a list selection input field and may be matched through said field reference annotation with the field reference of an annotation element specifying a list of selection option labels.

In some example embodiments, said form composition components may include an annotation element for marking the end of an option label within text specifying a list of option labels.

In some example embodiments, said form composition components may include an annotation element for marking one of a beginning or end of a line group including a plurality of lines of said specification.

In some example embodiments, said form composition components may include an element to display label text with an attribute specifying said label text.

In some example embodiments, said form composition components may include an element to display message text with an attribute specifying said message text.

In some example embodiments, said form composition components may include a display element to advance to the next of said field points on one of said lines.

In some example embodiments, at least one of said fields may have a default internal symbol value based on said line and said field point where the field is positioned in the interactive form.

In some example embodiments, at least one of the fields may have a unique internal symbol value based on label text provided by a nearest preceding element which displays label text in the same line of said display, and the internal symbol value may supersede a default internal symbol value.

In some example embodiments, at least one of the fields may have a unique internal symbol value based on label text provided by a nearest preceding element which displays label text in the same line of said display, and further based on label text provided by an element which displays label text in a preceding line of the specification which contains an annotation element marking the start of a line group, and the internal symbol value may supersede a default internal symbol value.

In some example embodiments, said end of said immediate predecessor field may be determined by adding to the beginning position of said immediate predecessor field the specified field width for said immediate predecessor field.

In some example embodiments, the immediate predecessor field may be a list selection input field, and said end of said immediate predecessor field may be determined by adding to the beginning position of said immediate predecessor field a field width estimated for a longest option label of said immediate predecessor field.

In some example embodiments, said end of said immediate predecessor field may be determined by adding to the beginning position of said immediate predecessor field a field width estimated for the label text of said immediate predecessor field, wherein said immediate predecessor field is a field to display label text.

In some example embodiments, said end of said immediate predecessor field may be determined by adding to the beginning position of said immediate predecessor field a field width estimated for the message text of said immediate predecessor field, wherein said immediate predecessor field is a field to display message text.

Some example embodiments may further include acquiring a user-supplied data value using one of a display element and a control having an identifier based on an internal symbol for one of the fields, and associating said data value with said one of the fields by means of said identifier.

In some example embodiments, said one of the fields may be a decimal integer input field, and such embodiments may further include validating the user supplied data, and rejecting user supplied data not representing a valid decimal integer.

In some example embodiments, said one of the fields may be a decimal fractional number input field, and such embodiments may further include validating the user supplied data, and rejecting user supplied data not representing a valid decimal fractional number.

In some example embodiments, said label text element may be included as a field in a form representation specifying for said field the ordinals of said line and said field point where said label text begins in said form, said field width of said label text, and the label text type of said field.

In some example embodiments, said message text element may be included as a field in a form representation specifying for said field the ordinals of said line and said field point where said message text begins in said form, said field width of said message text, and the message text type of said field.

In some example embodiments, at least one of the fields may be a text input field and said text input field may be included in a form representation specifying for said text input field the ordinals of said line and said field point where said text input field begins in said form, said field width of said text input field, said internal symbol value of said text input field, the text input type of said text input field, and the external symbol value of said text input field when said external symbol value has been specified.

In some example embodiments, at least one of the fields may be a decimal integer input field and said decimal integer input field may be included in a form representation specifying for said decimal integer input field the ordinals of said line and said field point where said decimal integer input field begins in said form, said field width of said decimal integer input field, said internal symbol value of said decimal integer input field, the decimal integer input type of said decimal integer input field, and the external symbol value of said decimal integer input field when said external symbol value has been specified.

In some example embodiments, at least one of the fields may be a decimal fractional number input field and said decimal fractional number input field may be included in a form representation specifying for said decimal fractional number input field the ordinals of said line and said field point where said decimal fractional number input field begins in said form, said field width of said decimal fractional number input field, said internal symbol value of said decimal fractional number input field, the decimal fractional number input type of said decimal fractional number input field, and the external symbol value of said decimal fractional number input field when said external symbol value has been specified.

In some example embodiments, at least one of the fields may be a checkbox mark input field and said checkbox mark input field may be included in a form representation specifying for said checkbox mark input field the ordinals of said line and said field point where said checkbox mark input field begins in said form, said field width of said checkbox mark input field, said internal symbol value of said checkbox mark input field, the checkbox mark input type of said checkbox mark input field, and the external symbol value of said checkbox mark input field when said external symbol value has been specified.

In some example embodiments, at least one of the fields may be a list selection input field, and said list selection input field may be included in a form representation specifying for said list selection input field the ordinals of said line and said field point where said list selection input field begins in said form, said field width of said list selection input field, said internal symbol value of said list selection input field, the list selection input type of said list selection input field, and the external symbol value of said list selection input field when said external symbol value has been specified.

In some example embodiments, said data value may be included in a form data representation specifying said internal symbol associated therewith and said data value.

In some example embodiments, said data value may be displayed as an initial value in said field of said form associated with said internal symbol.

In some example embodiments, said display element to advance to the next of said field points may be represented in said specification by a horizontal tab character.

In some example embodiments, said line separator may be represented in said specification by a newline character.

In some example embodiments, said line separator may be represented in said specification by a sequence of carriage return and line feed characters.

Other example embodiments may provide a system for providing interactive forms in Web application software, which may include a Web application server including a storage device and an application component; wherein the Web application server receives and stores, a specification of an interactive form as a form, the specification including an ordered sequence of components, wherein said components specify at least fields and line separators, and wherein said fields have field widths; and wherein the application component dynamically generates the interactive form for display according to the specification, wherein the interactive form is automatically configured as one or more lines, each with one or more field points, wherein all of said field points on one of said lines have equal spacing, wherein said spacing of field points on all of said lines is the same, wherein said spacing of field points is equivalent to at least twice the width of a typical displayed character, wherein the position of the first of said fields on one of said lines begins at the first of said field points on said line, and wherein the position of each successor field after said first field on one of said lines begins at the next of said field points on said line following the end of the immediate predecessor field.

Other example embodiments may provide a system for providing interactive forms in Web application software, which may include an element for receiving a specification of an interactive form, the specification including an ordered sequence of components, wherein said components specify at least fields and line separators, and wherein said fields have field widths; an element for storing the specification; and an element for dynamically generating the interactive form for display according to the specification, wherein the interactive form is automatically configured as one or more lines, each with one or more field points, wherein all of said field points on one of said lines have equal spacing, wherein said spacing of field points on all of said lines is the same, wherein said spacing of field points is equivalent to at least twice the width of a typical displayed character, wherein the position of the first of said fields on one of said lines begins at the first of said field points on said line, and wherein the position of each successor field after said first field on one of said lines begins at the next of said field points on said line following the end of the immediate predecessor field.

And other example embodiments may provide an article of manufacture, which may include a computer readable medium containing instructions which, when executed by a computer, cause the computer to receive a specification of an interactive form, the specification including an ordered sequence of components, wherein said components specify at least fields and line separators, and wherein said fields have field widths; store the specification; and dynamically generate the interactive form for display according to the specification, wherein the interactive form is automatically configured as one or more lines, each with one or more field points, wherein all of said field points on one of said lines have equal spacing, wherein said spacing of field points on all of said lines is the same, wherein said spacing of field points is equivalent to at least twice the width of a typical displayed character, wherein the position of the first of said fields on one of said lines begins at the first of said field points on said line, and wherein the position of each successor field after said first field on one of said lines begins at the next of said field points on said line following the end of the immediate predecessor field.

### BRIEF SUMMARY OF THE DRAWINGS

FIG. 1A illustrates an example SvForm composition document in accordance with an example embodiment of the present invention.

FIG. 1B illustrates an example SvForm display in accordance with an example embodiment of the present invention.

FIG. 2 illustrates example SvForm internal symbols as affected by a GM element in accordance with an example embodiment of the present invention.

FIG. 3 illustrates a system in accordance with an example embodiment of the present invention.

### DETAILED DESCRIPTION OF EXAMPLE EMBODIMENTS

Example embodiments of the present invention provide for a “simple validated form,” or SvForm, process, which includes a methodology to compose and modify forms, to display forms, to validate and acquire form inputs, and to store and retrieve form data, such that a Web application can provide both the presentation and recording of forms for normal operations and the composition and modification of forms for configuration. The users of a Web application employing those methodologies can be provided with a reasonably simple way to compose and modify the interactive forms they use to enter, edit and view information held in computer records. A Web application employing those methodologies has flexibility to adjust the appearance of forms, including their fonts and colors, so as to conform to conventions of the application, flexibility to present forms for either viewing or data input, flexibility to separate portions of forms and combine whole forms and portions of forms, flexibility to present one or multiple whole forms or portions of forms in one or multiple regions of a display, flexibility to associate, display and adjust images and charts with forms, and flexibility to provide and dynamically adjust validation of form inputs as appropriate for an application. The SvForm process provides methodologies to represent both forms and associated form data.

The SvForm process is based on a paradigm automatically dividing a form display into lines with uniformly spaced field points on each line. Field point spacings are the same within a form but may vary between forms; they may be equivalent to twice the width of a typical displayed character or more. Fields of a form have widths that may be specified or may be set by defaults. As displayed, all fields of a form begin at field points. In the absence of other specifications, the first field specified on a line begins at the first field point on the line, and each successor field specified on a line begins at the next field point on the line following the end of its immediate predecessor field. Fields of a form can optionally be identified by using an automatically generated internal symbol (e.g., an internal name using which a web application may identify and reference a field) reflecting the line ordinal and field point ordinal at the start of the field when displayed.

The SvForm process generates a form display dynamically, by interpreting a form specification. A form specification, whether manipulated literally or visually, may be composed or modified by a user and interpreted by a Web application in some way. The SvForm process provides a “form composition” language for this purpose. When a Web application provides visual manipulation or preview to compose and modify forms, a form composition document acts as an intermediary between describing and displaying a form. An SvForm form composition document may include an ordered sequence of form components. The SvForm form composition language provides at least text inputs and line separators as form components.

A form specification may be stored as a form composition document or in some other way. In some example embodiments, the SvForm process may provide an optional “form representation” for this purpose. Form data may be stored in form composition or form representation formats or in some other way. The SvForm process may provide an optional “form data representation” for this purpose. A form representation and a form data representation are intended for persistent storage, typically in databases or data files. Internal, working representations of forms and form data within Web application software may differ.

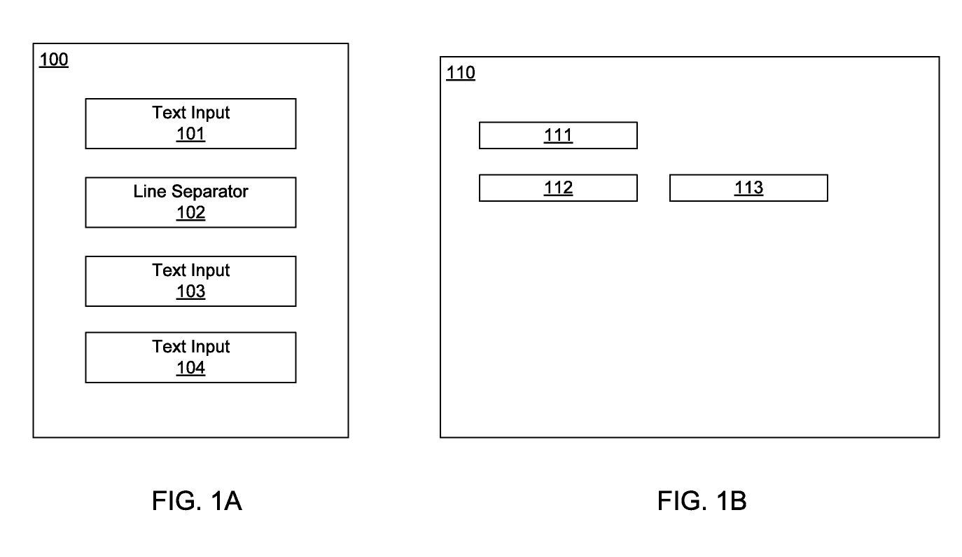

FIG. 1A shows schematically an example SvForm form composition document 100 with three text inputs 101, 103, 104 and one line separator 102. Only the order of the text inputs 101, 103, 104 and the line separator 102 is significant. FIG. 1B shows schematically a form display 110 generated using the specification shown in FIG. 1A, in which the first line has one text input 111 and the second line has two text inputs 112, 113. Optional internal symbols automatically generated for the input fields will reflect line ordinals 1 and 2 and field point ordinal 1 for the first inputs on the lines.

The components of an SvForm form composition document may include the following element types, listed by nominal element tags, element types and purposes:

| | | |
|---|---|---|
| TF | text field | input for text |
| IF | integer field | input for decimal integer |
| FF | fractional field | input for decimal fractional number |
| CF | checkbox field | input for checkbox mark |
| LF | list field | input for list selection |
| FM | field mark | annotation for end of input field |
| RM | reference mark | annotation for field reference |
| VM | value mark | annotation for field default value |
| SM | symbol mark | annotation for field symbol |
| LM | list mark | annotation for list field options |
| OM | option mark | annotation for end of option label |
| GM | group mark | annotation for start or end of line group |
| LT | label text | display of fixed text in label |
| MT | message text | display of fixed text in message |
| FS | field separator | display of next field point on form line |
| LS | line separator | display of next form line at first field |

The SvForm process may describe form components using nominal element tags. For example, the tags may appear in form composition documents. Implementations may represent tags differently. One skilled in software arts will recognize other syntax expressing the same meanings.

Preferably an SvForm input field is specified by a TF, IF, FF, CF or LF element followed by attributes, if any, and an FM element; but an FM element may be omitted when the next form component is an FS or LS element. Optional attributes associated with SvForm elements vary with element type. Preferably the TF, IF and FF elements may have a field width attribute: a decimal integer following an element tag; the SvForm process uses an implementation-specified default when a field width attribute is omitted. The optional LT, MT and LF elements have data attributes. For LT and MT elements the data attribute may be text following an element tag. The LT elements cause text to be displayed in a form and also change optional internal symbols automatically generated for following TF, IF, FF, CF and LF elements. The MT elements may cause text to be displayed in a form without affecting internal symbols. For LF elements the data attribute may be an “option list” following an element tag. An option list is text separated into option labels by OM elements. An empty or duplicate option label may be ignored. A data attribute for an element ends at the next FS or LS element, at the end of a document or, for an option list, at the next RM or FM element. Preferably leading and trailing spaces in data attribute text and option labels are trimmed, and only embedded spaces are retained.

Preferably the optional SvForm TF, IF, FF, CF and LF elements may have a reference attribute, which may be an RM element and decimal integer following an element tag and any other attribute. The TF, IF, FF, CF and LF elements are supported by optional SM symbol annotation, allowing a form composition document to specify external symbols, and they are also supported by optional VM value annotation, allowing a form composition document to specify default values. The LF elements are supported by optional LM list annotation, allowing a form composition document to specify option lists separately from the LF elements to which they apply.

Optional SvForm referenced annotations are linked to TF, IF, FF, CF and LF elements through reference attributes. Referenced annotations are composite components including an RM element and decimal integer, followed by an SM, VM or LM element, followed by a data attribute. They are recognized only on lines of a form composition document beginning with one of them, and such document lines are not displayed in a form. For an SM annotation, the data attribute is text specifying an external symbol for a referenced TF, IF, FF, CF or LF element. For a VM annotation, the data attribute is text specifying a default value for a referenced TF, IF, FF, CF or LF element. Default values for optional CF elements are implementation-specified, such as “T” for checked and “F” for unchecked. For an LM annotation, the data attribute is an option list specifying option labels for a referenced LF element and superceding any option labels specified in that element. A data attribute for a referenced annotation ends at the next RM, FS or LS element or at the end of a document. In some embodiments a referenced annotation is ignored if its reference does not match an element with a reference attribute, a default value is ignored if it does not match valid values for the referenced field, and an LM annotation is ignored if the referenced element is not an LF element. If there are multiple referenced annotations of the same type for the same referenced element, preferably the last one is accepted.

Preferably an optional SvForm TF, IF, FF, CF or LF element has an automatically generated default internal symbol reflecting the line ordinal and field point ordinal at the start of a corresponding displayed field, and preferably when such an element follows an LT element on the same line the default internal symbol is superceded by an automatically generated internal symbol that reflects the data attribute of the LT element, so constructed that all internal symbols in a form are different. Preferably when a form composition document line begins with a GM element, followed by one or more LT elements, the data attributes of those LT elements are combined, field by field, with the data attributes of LT elements on following form composition document lines to provide automatically generated internal symbols for TF, IF, FF, CF and LF elements on those lines, field by field, reflecting data attributes of paired LT elements, so constructed that all internal symbols in a form are different. Preferably such behavior continues until it is modified by another form composition document line beginning with a GM element, followed by one or more LT elements, or it is ended by a form composition document line beginning with a GM element and containing no other elements, a form composition document line not displayed in a form. These techniques allow limited repositioning of form components without changing internal symbols.

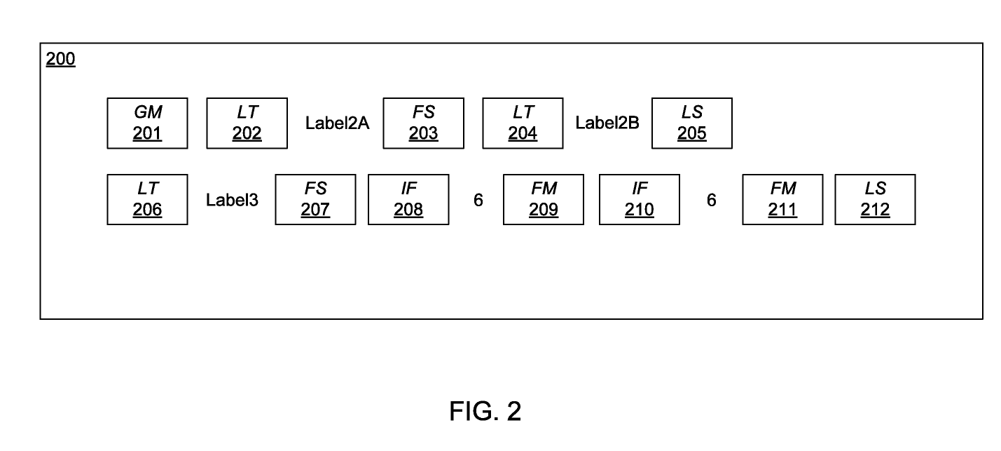

FIG. 2 shows schematically part of an SvForm form composition document 200 that includes optional elements: a GM group mark element 201, three LT label text elements 202, 204, 206, two IF decimal integer input elements 208, 210 with field width 6, and other annotation and display elements. On the second line, the first decimal integer input element 208 has an internal symbol reflecting both the “Label2A” and the “Label3” label text elements 202, 206, and the second decimal integer input element 210 has an internal symbol reflecting both the “Label2B” and the “Label3” label text elements 204, 206. That is, because a GM element starts the first line and is not terminated, the integer input elements 208, 210 appearing on the second line receive internal symbols reflecting not only the LT element 206 from the second line, on which they appear, but also reflecting the LT elements 202, 204 from the line above, on a field by field basis. The first IF element 208 on the second line identifies the first field appearing on that line and, accordingly, receives an internal symbol associated with the first LT element 202 appearing on the line above.

When displaying a form described in a form composition document, the SvForm process preferably estimates widths of optional LF, LT and MT elements from their data attributes. The LF elements have field widths set by lengths of their longest option labels. The LT and MT elements have field widths set by lengths of their data attributes. The optional CF elements have implementation-specified field widths. Preferably field widths are measured in en quadrats, and the SvForm process estimates displayed widths, multiplying character counts by the width of an en quadrat. Preferably, when the specified or estimated width of a displayed field reaches but does not exceed the location of a field point, if the next element on a line is FS the SvForm process advances to the following field point as the start of a succeeding element, but otherwise it uses the field point that was reached as the start of the next element on a line. Preferably the SvForm process uses automatically generated internal symbols of form elements to provide identifiers for dynamically constructed display elements or controls, and it specifies display positions based on line spacing and field point spacing. When acquiring data from a user for inputs displayed in a form described by a form composition document, the SvForm process preferably associates inputs with corresponding TF, IF, FF, CF and LF elements using automatically generated internal symbols of elements.

The SvForm process provides optional validation for IF and FF numeric input fields, rejecting invalid data. The identifiers for displayed elements or controls in a form described by a form composition document are referenced by dynamically constructed validation controls. Preferably validation occurs on user computers, notifying users of invalid data and preventing their transmission to servers. Preferably validation can be dynamically enabled or disabled separately for each element to which it applies.

When providing an optional form representation, the SvForm process also preferably provides translation from a form composition document to a form representation and from a form representation to a form composition document, so that a form representation can be used as the sole document for persistent storage of a form specification, while an equivalent form composition document can be regenerated as needed for use when modifying a form. Optional SvForm form representations can be organized as data grids, outlines, unstructured tagged values or structured tags, as in XML. Preferably a form representation is organized by lines and fields and specifies for each displayed field the line ordinal, starting field point ordinal, field type, field attributes, internal symbol and external symbol. Translation from a form composition document to a form representation uses the same techniques as displaying a form, in which the specified or estimated width of a displayed field determines the field point for the start of a following field. Otherwise specifications of fields in a form representation are copied from those of corresponding form components in a form composition document, taking into account optional referenced annotations. Translation from a form representation to a form composition document proceeds line by line and field by field, using the specified or estimated width of a displayed field based on its attributes to determine when optional FS elements must be inserted so as to represent the corresponding pattern of field locations. Otherwise specifications of form components in a form composition document are copied from those of corresponding fields in a form representation. Preferably translation from a form representation to a form composition document inserts an optional FM element after each optional TF, IF, FF, CF and LF element and its attributes, inserts optional SM, VM and LM referenced annotations after all displayed form components, and uses optional LM referenced annotations to specify the option lists for optional LF elements.

When providing an optional form data representation the SvForm process also preferably provides, on displaying a form, optional initial values for input fields from form data. Preferably the SvForm process provides options to display such initial values in forms by using input elements and controls or by using view-only elements and controls. For such a purpose correspondences must be chosen between types of elements or controls used for input displays and type of elements or controls used for view-only displays. Preferably a text or number input element or control corresponds with a label or fixed text view-only element or control and not with a disabled input element or control. Optional SvForm form data representations can be organized as outlines, unstructured tagged values or structured tags, as in XML. Preferably a form data representation is organized by internal form symbols and specifies for each internal form symbol a corresponding data value. Preferably the SvForm process matches data with form fields through internal symbols, determining data types and component attributes when necessary by means of a corresponding optional form representation. Preferably the SvForm process also provides retrieval of data from a form data representation through references to external symbols, whose meanings can be preserved across any rearrangement of a form, provided data types do not change. A corresponding form representation is used to obtain associations between external symbols and internal symbols. Actions to be taken on finding association of an external symbol with two or more different components of a form are implementation-specified. Preferably such actions occur when a form composition document has been composed or edited and result in elimination of such duplicate uses of a symbol before the document is stored or translated to a form representation. Preferably the SvForm process provides dynamic form displays based on form representations and form data representations, automatically translating form composition documents to form representations to provide form displays.

Optionally the SvForm process can separate a form into portions, as specified by intervals of line ordinals and field point ordinals and can combine forms and portions of forms. Preferably, when separating a form into portions, it estimates a form width sufficient to contain all displayed form components within specified intervals. Preferably, when combining forms and portions of forms, it uses the largest of their field point spacings as a field point spacing for the result. The SvForm process provides optional conversion of a form specification from a form composition document, form representation or both to another type of document that can be utilized by a Web application tool set to provide a static form, translating input components to equivalents when available in the document type and otherwise to text inputs, and using tables, style attributes or other means provided by the document type to indicate field positions. The representations for element tags used by an SvForm process implementation may eliminate certain characters from those recognized in data attributes. The first or only characters used for FM, FS, and LS tag representations cannot be recognized in data attributes. Optionally representing the LS tag by newline or carriage return and line feed and the FS tag by horizontal tab can approximate a form display in the display of a form composition document, provided there is display support for newline and display support for horizontal tab at a spacing close to the field point spacing of a form. Preferably spaces other than those specified by an implementation as part of an element tag and those embedded in data attributes and option labels are ignored, allowing spaces to be used to improve readability of a form composition document.

For example, a user of a Web application may access a form which may be a configured form, or a user configured form, etc. That form may be described by a form composition document as discussed above, or another similar description. As noted, the form specification, whether in the form of a form composition document or otherwise, may define a number of form elements that are to be displayed.

The Web application may interpret the form specification, as described above, and, based on the specification, may generate a form for display to the user. For example, in some embodiments of the application, a Web server running Web application software may interpret the form specification and may generate HTML designed to render the form on the user's Web browser. In other examples, the user's machine may interpret the form specification and may render the form for display, etc. In any event, the form for display may be created according to the general principles described above, for instance, determining where on the form an LT element will be displayed. In addition, all of the other features described above may also be implemented. Thus, the elements of the form as specified may be associated with internal symbols, by which they may be identified and referenced.

In addition, the Web application may also present the user with the ability to alter the form, or to create new forms. For example, the Web application may provide the user with an interface, using which the user may edit the elements of a form composition document that describes a form. The Web application may also allow the user to save the edited form and may interpret and display that form as described above. In other example embodiments, a Web application may present a user with a graphical tool which may be used to edit or create forms. Thus the user may be able to introduce new fields into a form by dragging a representation of a field into the form, etc. In such a case, the Web application may create a specification for the edited or new form based on the user's input, e.g., in the form of a form composition document, and may save that specification.

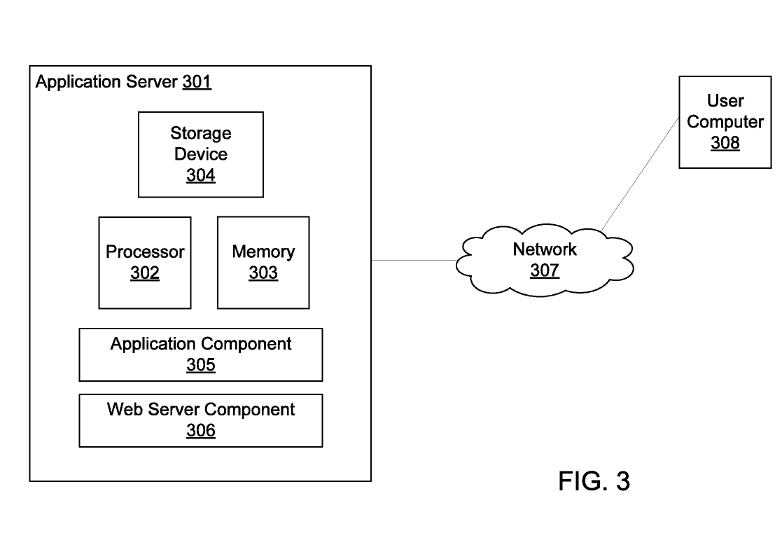

Other example embodiments of the present invention provide systems for the creation and display of forms according to the example processes described above. For instance, as illustrated in FIG. 3, some example systems may provide an application server 301. The application server 301 may include a processor 302, a memory 303, and a storage device 304. In addition, the server 301 may also include an I/O device, through which it may be in communication with a network 307, e.g., the Internet.

The application server 301 may also include a application component 305. The application component 305 may be configured to receive interactive form specifications from users, as described more fully above. For example, the application component 305 may be configured to receive specifications in the form of a form composition document. The application component 305 may also provide users with an interface facilitating the creation of form specifications. For instance, the application component may provide users with an interface allowing users to identify any of the form components discussed above.

Once a specification is received, the application component 305 may also be configured to store the specification. For instance, the form specification may be stored in the storage device 304, or may be stored on another local or remote storage system. Also as explained above, the specification may be stored as a form composition document or may be stored in another format.

The application component 305 may also be configured to generate and display an interactive form based on a form specification. For example, the application component 305 may receive a user request for a form and may use a form specification to generate that form automatically, according to the processes described herein. The application component 305 may also be configured to display the form to the requesting user. For instance, the application component 305 may transmit information relating to the display of the form to the user, for example through a web server component 306, which may be configured to process all of the transactions typically associated with Web pages; for instance utilizing using web server systems currently available, such as, e.g., the Apache web server software, which may, for instance, be stored on the storage device 304 and executed using the processor 302 and memory 303.

It will be understood that the procedures described herein may be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It will further be appreciated that the above-described methods and procedures may be provided using the systems disclosed herein, or on other types of systems. The methods and procedures, unless expressly limited, are not intended to be read to require particular actors or systems performing particular elements of the methods.

It will also be appreciated that the system components discussed herein may be provided as hardware, firmware, software or any combination thereof. If provided as software, such software may be stored in memory, for example in RAM, ROM, flash or other non-volatile memory, etc., or may be stored on another machine readable medium, such as magnetic or optical media, etc. In addition such software may be preloaded, or may be acquired and stored during functioning of a system.

In the preceding specification, the present invention has been described with reference to specific example embodiments thereof. It will, however, be evident that various modifications and changes may be made thereunto without departing from the broader spirit and scope of the present invention. The description and drawings are accordingly to be regarded in an illustrative rather than restrictive sense.

1. A process for providing interactive forms in Web application software, comprising:
receiving, with a Web application server, a specification of an interactive form, the specification including an ordered sequence of components, wherein said components specify at least fields and line separators, and wherein said fields have field widths;
storing the specification, with the Web application server;
dynamically generating, with the Web application server, the interactive form for display according to the specification, wherein the interactive form is automatically configured as one or more lines, each with one or more field points, wherein all of said field points on one of said lines have equal spacing, wherein said spacing of field points on all of said lines is the same, wherein said spacing of field points is equivalent to at least twice the width of a typical displayed character, wherein the position of the first of said fields on one of said lines begins at the first of said field points on said line, and wherein the position of each successor field after said first field on one of said lines begins at the next of said field points on said line following the end of the immediate predecessor field.

2. The process of claim 1 wherein one or more of said field widths are specified in said specification.

3. The process of claim 1 wherein one or more of said field widths are set by defaults.

4. The process of claim 1 further comprising automatically generating an internal symbol to identify at least one of the fields, the internal symbol reflecting the line ordinal and the field point ordinal at the start of said field as displayed.

5. The process of claim 1, further comprising receiving data corresponding to said fields in said interactive form from user inputs for said fields.

6. The process of claim 1, wherein the specification is stored in a form representation that differs from a form composition document.

7. The process of claim 1, wherein the specification is stored as a form composition document.

8. The process of claim 5, further comprising storing the data in a form data representation that differs from a form composition document.

9. The process of claim 1 wherein said at least one of the fields is one of a text input field, a decimal integer input field, decimal fractional number input field, a checkbox mark input field, and a list selection input field.

10. The process of claim 9 wherein at least one of the fields includes a field width attribute.

11. The process of claim 9 wherein at least one of the fields is a list selection input field and includes an attribute specifying a list of selection option labels.

12. The process of claim 1 wherein said form composition components include an annotation element for marking the end of an input field specification.

13. The process of claim 1 wherein said form composition components include an annotation element for a field reference.

14. The process of claim 1 wherein said field includes a field reference annotation.

15. The process of claim 1 wherein said form composition components include an annotation element for specifying a field default value, including a field reference.

16. The process of claim 14 wherein at least one of the fields is matched through said field reference annotation with the field reference of an annotation element specifying a default value.

17. The process of claim 1 wherein said form composition components include an annotation element for specifying a field external symbol, including a field reference.

18. The process of claim 14 wherein at least one of the fields is matched through said field reference annotation with the field reference of an annotation element specifying a field external symbol.

19. The process of claim 1 wherein said form composition components include an annotation element for specifying a list of selection option labels.

20. The process of claim 14 wherein at least one of the fields is a list selection input field and is matched through said field reference annotation with the field reference of an annotation element specifying a list of selection option labels.

21. The process of claim 1 wherein said form composition components include an annotation element for marking the end of an option label within text specifying a list of option labels.

22. The process of claim 1 wherein said form composition components include an annotation element for marking one of a beginning or end of a line group including a plurality of lines of said specification.

23. The process of claim 1 wherein said form composition components include an element to display label text with an attribute specifying said label text.

24. The process of claim 1 wherein said form composition components include an element to display message text with an attribute specifying said message text.

25. The process of claim 1 wherein said form composition components include a display element to advance to the next of said field points on one of said lines.

26. The process of claim 1 wherein at least one of said fields has a default internal symbol value based on said line and said field point where the field is positioned in the interactive form.

27. The process of claim 1 wherein at least one of the fields has a unique internal symbol value based on label text provided by a nearest preceding element which displays label text in the same line of said display, and wherein the internal symbol value supersedes a default internal symbol value.

28. The process of claim 1 wherein at least one of the fields has a unique internal symbol value based on label text provided by a nearest preceding element which displays label text in the same line of said display, and further based on label text provided by an element which displays label text in a preceding line of the specification which contains an annotation element marking the start of a line group, and wherein the internal symbol value supersedes a default internal symbol value.

29. The process of claim 1 wherein said end of said immediate predecessor field is determined by adding to the beginning position of said immediate predecessor field the specified field width for said immediate predecessor field.

30. The process of claim 1 wherein the immediate predecessor field is a list selection input field, and wherein said end of said immediate predecessor field is determined by adding to the beginning position of said immediate predecessor field a field width estimated for a longest option label of said immediate predecessor field.

31. The process of claim 1 wherein said end of said immediate predecessor field is determined by adding to the beginning position of said immediate predecessor field a field width estimated for the label text of said immediate predecessor field, wherein said immediate predecessor field is a field to display label text.

32. The process of claim 1 wherein said end of said immediate predecessor field is determined by adding to the beginning position of said immediate predecessor field a field width estimated for the message text of said immediate predecessor field, wherein said immediate predecessor field is a field to display message text.

33. The process of claim 1, further comprising acquiring a user-supplied data value using one of a display element and a control having an identifier based on an internal symbol for one of the fields, and associating said data value with said one of the fields by means of said identifier.

34. The process of claim 33 wherein said one of the fields is a decimal integer input field, the process further comprising validating the user supplied data, and rejecting user supplied data not representing a valid decimal integer.

35. The process of claim 33 wherein said one of the fields is a decimal fractional number input field, the process further comprising validating the user supplied data, and rejecting user supplied data not representing a valid decimal fractional number.

36. The process of claim 23 wherein said label text element is included as a field in a form representation specifying for said field the ordinals of said line and said field point where said label text begins in said form, said field width of said label text, and the label text type of said field.

37. The process of claim 24 wherein said message text element is included as a field in a form representation specifying for said field the ordinals of said line and said field point where said message text begins in said form, said field width of said message text, and the message text type of said field.

38. The process of claim 27 wherein at least one of the fields is a text input field and said text input field is included in a form representation specifying for said text input field the ordinals of said line and said field point where said text input field begins in said form, said field width of said text input field, said internal symbol value of said text input field, the text input type of said text input field, and the external symbol value of said text input field when said external symbol value has been specified.

39. The process of claim 27 wherein at least one of the fields is a decimal integer input field and said decimal integer input field is included in a form representation specifying for said decimal integer input field the ordinals of said line and said field point where said decimal integer input field begins in said form, said field width of said decimal integer input field, said internal symbol value of said decimal integer input field, the decimal integer input type of said decimal integer input field, and the external symbol value of said decimal integer input field when said external symbol value has been specified.

40. The process of claim 27 wherein at least one of the fields is a decimal fractional number input field and said decimal fractional number input field is included in a form representation specifying for said decimal fractional number input field the ordinals of said line and said field point where said decimal fractional number input field begins in said form, said field width of said decimal fractional number input field, said internal symbol value of said decimal fractional number input field, the decimal fractional number input type of said decimal fractional number input field, and the external symbol value of said decimal fractional number input field when said external symbol value has been specified.

41. The process of claim 27 wherein at least one of the fields is a checkbox mark input field and said checkbox mark input field is included in a form representation specifying for said checkbox mark input field the ordinals of said line and said field point where said checkbox mark input field begins in said form, said field width of said checkbox mark input field, said internal symbol value of said checkbox mark input field, the checkbox mark input type of said checkbox mark input field, and the external symbol value of said checkbox mark input field when said external symbol value has been specified.

42. The process of claim 27 wherein at least one of the fields is a list selection input field, and said list selection input field is included in a form representation specifying for said list selection input field the ordinals of said line and said field point where said list selection input field begins in said form, said field width of said list selection input field, said internal symbol value of said list selection input field, the list selection input type of said list selection input field, and the external symbol value of said list selection input field when said external symbol value has been specified.

43. The process of claim 33 wherein said data value is included in a form data representation specifying said internal symbol associated therewith and said data value.

44. The process of claim 43 wherein said data value is displayed as an initial value in said field of said form associated with said internal symbol.

45. The process of claim 25 wherein said display element to advance to the next of said field points is represented in said specification by a horizontal tab character.

46. The process of claim 1 wherein said line separator is represented in said specification by a newline character.

47. The process of claim 1 wherein said line separator is represented in said specification by a sequence of carriage return and line feed characters.

48. A system for providing interactive forms in Web application software, comprising:
a Web application server including a storage device and an application component;
wherein the Web application server receives and stores, a specification of an interactive form as a form, the specification including an ordered sequence of components, wherein said components specify at least fields and line separators, and wherein said fields have field widths; and
wherein the application component dynamically generates the interactive form for display according to the specification, wherein the interactive form is automatically configured as one or more lines, each with one or more field points, wherein all of said field points on one of said lines have equal spacing, wherein said spacing of field points on all of said lines is the same, wherein said spacing of field points is equivalent to at least twice the width of a typical displayed character, wherein the position of the first of said fields on one of said lines begins at the first of said field points on said line, and wherein the position of each successor field after said first field on one of said lines begins at the next of said field points on said line following the end of the immediate predecessor field.

49. A system for providing interactive forms in Web application software, comprising:
means for receiving a specification of an interactive form, the specification including an ordered sequence of components, wherein said components specify at least fields and line separators, and wherein said fields have field widths;
means for storing the specification; and
means for dynamically generating the interactive form for display according to the specification, wherein the interactive form is automatically configured as one or more lines, each with one or more field points, wherein all of said field points on one of said lines have equal spacing, wherein said spacing of field points on all of said lines is the same, wherein said spacing of field points is equivalent to at least twice the width of a typical displayed character, wherein the position of the first of said fields on one of said lines begins at the first of said field points on said line, and wherein the position of each successor field after said first field on one of said lines begins at the next of said field points on said line following the end of the immediate predecessor field.

50. An article of manufacture comprising a computer readable medium containing instructions which, when executed by a computer, cause the computer to:
receive a specification of an interactive form, the specification including an ordered sequence of components, wherein said components specify at least fields and line separators, and wherein said fields have field widths;
store the specification; and
dynamically generate the interactive form for display according to the specification, wherein the interactive form is automatically configured as one or more lines, each with one or more field points, wherein all of said field points on one of said lines have equal spacing, wherein said spacing of field points on all of said lines is the same, wherein said spacing of field points is equivalent to at least twice the width of a typical displayed character, wherein the position of the first of said fields on one of said lines begins at the first of said field points on said line, and wherein the position of each successor field after said first field on one of said lines begins at the next of said field points on said line following the end of the immediate predecessor field.
